(19) United States
(12) Patent Application Publication
(10) Pub. No.: US 2019/0200223 A1
(43) Pub. Date: Jun. 27, 2019

(54) WIRELESS NETWORK-BASED BIOMETRIC AUTHENTICATION SYSTEM, A MOBILE DEVICE AND A METHOD THEREOF

(71) Applicant: KEYSSMART TECHNOLOGY LIMITED, Jiang Men City (CN)

(72) Inventor: Kwok Fong WONG, JIANG MEN CITY (CN)

(21) Appl. No.: 16/018,100

(22) Filed: Jun. 26, 2018

(30) Foreign Application Priority Data
Dec. 25, 2017 (CN) 201711419649.7

(51) Int. Cl. H04W 12/06; H04W 4/80; G06F 21/32; G06F 21/35; G06F 21/60

(52) U.S. Cl. CPC H04W 12/06; H04W 4/80; H04L 67/10; G06F 21/35; G06F 21/602; G06F 21/32

(57) ABSTRACT

The present invention discloses a wireless network-based biometric authentication system, a mobile device and a method thereof, the system comprises a biometric authentication device, a mobile device, and a cloud device; the biometric authentication device authenticates the biometrics input by a user and sends first encrypted data to a mobile device via Bluetooth communication when the authentication succeeds; the mobile device decrypts the first encrypted data to obtain the first random password and the identity authentication identification code, and downloads the first random information and the identity information of the biometric authentication device from the cloud device; the first random information and the identity information are transmitted to the cloud device by the mobile device; the mobile device is used to pass the verification when the first random password corresponds to the first random information and the identity code corresponds to the identity information. The invention obtains random password via Bluetooth and downloads the prestored random password from the cloud for verification, so as to avoid the problems caused by the loss of mobile phone and ensure the security of verification.

### FIELD OF THE INVENTION

The present invention relates to a biometric authentication field, and in particular to a wireless network-based biometric authentication system, a mobile device and a method thereof.

### BACKGROUND

With the development of mobile payment and biometric authentication technology, biometric authentication based on mobile devices has become more and more popular. At present, the common authentication process is as follows.

A user obtains the biometric information input by the user based on the biometric information acquisition device such as the fingerprint input device, and then sends the information to the mobile device for authentication. The mobile device compares the biometric information with the pre-stored biometric information, and if passing the comparison, the authentication is successful. However, once the mobile phone software is uninstalled or the mobile phone is lost or a new mobile phone is replaced, the user cannot authenticate or needs to register all accounts and biometric information on the new mobile phone, causing inconvenience to users.

### SUMMARY

The object of the present invention is to overcome the foregoing problems and shortcomings and provide a wireless network-based biometric authentication system, a mobile device and a method thereof, so as to solve the problems.

The technical solutions of the present invention are achieved by the following way.

On one aspect, the present invention discloses a wireless network-based biometric authentication system, comprising a biometric authentication device, a mobile device, and a cloud device;

Wherein the biometric authentication device is configured to authenticate the biometric input by the user and send first encrypted data to the mobile device via Bluetooth communication when the authentication succeeds; the first encrypted data are obtained by encrypting a first random password and an identity code of the biometric authentication device; and the first random password is generated when the previous authentication of the biometric authentication device succeeds;

The mobile device is configured to decrypt the first encrypted data to obtain a first random password and an identity authentication identification code, and download first random information and identity information of the biometric authentication device from the cloud device; first random information and identity information are transmitted to the cloud device from the mobile device;

The mobile device is further configured to pass the verification when the first random password corresponds to the first random information and the identity code corresponds to the identity information.

Preferably, the biometric authentication device is further configured to send second encrypted data to the mobile device via Bluetooth communication when the authentication succeeds, and the second encrypted data are obtained by encrypting a second random password and an identity code; the second random password is generated when the biometric authentication device succeeds in this authentication;

The mobile device is further configured to decrypt the second encrypted data to obtain a second random code and an identity authentication identification code, and transmit the second random information corresponding to the second random password and the identity information corresponding to the identity authentication identification code to the cloud device.

Preferably, the biometric authentication device and the cloud device store biometric information, and the biometric information corresponds to the identity information;

The cloud device is further configured to send the biometric information to a new biometric authentication device via the mobile device and store the identity code of the new biometric authentication device when receiving a request of replacing or adding a new biometric authentication device.

Preferably, the biometric authentication device is obtained through an AES128 encryption algorithm.

In another aspect, the present invention further discloses a wireless network-based mobile device, comprising a communication unit, a decryption unit and a verification unit;

the communication unit is used to used to receive first encrypted data sent by the biometric authentication device and first random information and identity information of the biometric authentication device sent by the cloud device; the first random information and identity information are transmitted to the cloud device by the transmission unit; the first encrypted data are sent via Bluetooth communication when the biometric authentication device successfully authenticates biometrics input by users; the first encrypted data are obtained by encrypting the first random password and the identity code of the biometric authentication device by the biometric authentication device; the first random password is generated when the biometric authentication device succeeds in the previous authentication;

the decryption is used to decrypt the first encrypted data to obtain a first random password and an identity authentication identification code;

the verification unit is used to pass the verification when the first random password corresponds to the first random information and the identity code corresponds to the identity information.

Preferably, the communication unit is further used to receive second encrypted data transmitted via Bluetooth communication when the biometric authentication device succeeds in authentication, and the second encrypted data are obtained by encrypting the second random password and the identity code; the second random password is generated when the biometric authentication device succeeds in this authentication;

The decryption unit is further used to decrypt the second encrypted data to obtain a second random password and an identity authentication identification code;

The communication unit is further used to transmit the second random information corresponding to the second random password and the identity information corresponding to the identity authentication identification code to the cloud device.

Preferably, the communication unit is further used to receive the biometric information sent by the cloud device and send it to a new biometric authentication device, and send the identity information corresponding to the identity code of the new biometric authentication device to a new biometric device, the biometric information is sent by the cloud device when receiving a request of replacing or adding a new biometric authentication device;

The biometric information corresponds to identity information.

In another aspect, the present invention further discloses a wireless network-based biometric authentication method applied in the aforesaid system, comprising:

a biometric authentication device authenticates the biometrics input by a user and sends first encrypted data to a mobile device via Bluetooth communication when the authentication succeeds; the first encrypted data are obtained by encrypting the first random password and the identification code of the biometric authentication device; the first random password is generated when the biometric authentication device succeeds in the previous authentication;

a mobile device decrypts the first encrypted data to obtain the first random password and the identity authentication identification code, and downloads the first random information and the identity information of the biometric authentication device from the cloud device; the first random information and the identity information are transmitted to the cloud device by the mobile device;

The mobile device is used to pass the verification when the first random password corresponds to the first random information and the identity code corresponds to the identity information.

Preferably, a biometric authentication device sends second encrypted data to the mobile device via Bluetooth communication when the authentication succeeds, and the second encrypted data are obtained by encrypting the second random password and the identity code; the second random password is generated when the biometric authentication device succeeds in this authentication;

A mobile device decrypts the second encrypted data to obtain a second random password and an identity authentication identification code and transmits the second random information corresponding to the second random password and the identity information corresponding to the identity authentication identification code to the cloud device.

Preferably, the biometric authentication device and the cloud device store biometric information, and the biometric information corresponds to the identity information;

The cloud device sends the biometric information to a new biometric authentication device via the mobile device and stores the identity code of the new biometric authentication device when receiving a request of replacing or adding a new biometric authentication device.

Beneficial Effects:

The wireless network-based biometric authentication system provided in the present invention stores authentication information in a biometric authentication device and a cloud device. When the mobile device performs authentication, it needs to obtain technically relevant information from the biometric authentication device and the cloud device for authentication. Compared with the prior art, users do not need to rely on a mobile phone, and they can perform biometric authentication as long as they can login to the mobile device of the cloud account.

### BRIEF DESCRIPTION OF THE DRAWINGS

The present invention is further described in combination with the accompanying drawings, which constitute a part of this application. The illustrative embodiments of the present invention and description thereof are used to explain the present invention rather than limit the present invention improperly. In the figures:

FIG. 1 is a system configuration diagram of the present invention;

FIG. 2 is a flowchart of the present invention.

### DETAILED DESCRIPTION

It should be noted that embodiments in the present application and the technical features in the embodiments can be combined with each other without conflict. The present application will be described in detail below with reference to the drawings and in combination with the embodiments.

It is to be noted that the terms used herein are merely used to describe specific embodiments and are not intended to limit the exemplary embodiments according to the present application. As used herein, the singular forms are intended to include the plural forms unless otherwise clearly indicated. In addition, it should be understood that, when the terms “comprise” and/or “include” are used in this specification, it indicates the existing features, steps, operations, devices, components, and/or combinations thereof.

The present invention provides a wireless network-based biometric authentication system, comprising a biometric authentication device, a mobile device (a mobile phone in the embodiment), and a cloud device. In the following embodiments, fingerprints are used as an example of biometrics, and biometric wireless key is used an example of the biometric authentication device. Apparently, other biometrics or biometric combinations or combination of biometrics and other passwords are covered in this application.

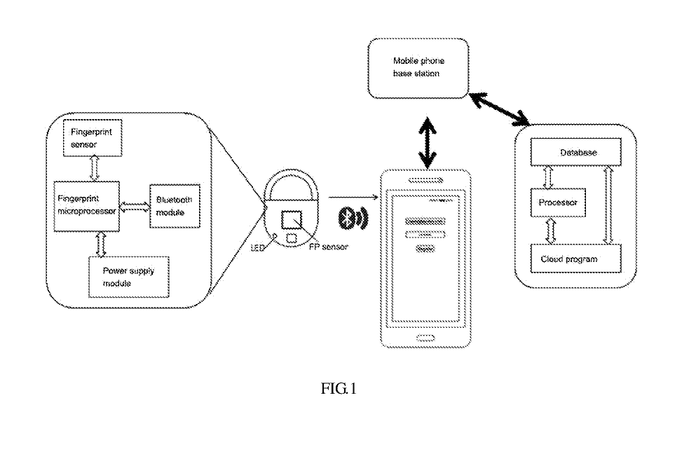

Referring to FIG. 1, the system comprises three parts: a biometric wireless key, a mobile phone, and a cloud.

Wherein, the biometric wireless key is internally composed of a fingerprint module, a Bluetooth module (BLE Module), and a power supply module.

The fingerprint module is used to implement functions of collecting, processing, storing, and identifying fingerprints, etc. Specifically, it can be composed of a fingerprint sensor, a fingerprint microprocessor, and a memory chip, etc. The fingerprint sensor is used to collect fingerprints, the fingerprint microprocessor is used to process and identify fingerprints, and the memory chip is used to store fingerprints.

The Bluetooth module (BLE Module) is used to implement information transmission between a biometric wireless key and a mobile phone. For example, the information on success or failure of collecting and identifying fingerprints by a fingerprint module is encrypted and transmitted to a mobile phone software together with the power supply voltage information of the biometric wireless key, and then transmitted to the cloud via the mobile phone software. In this embodiment, the AES128 encryption algorithm may be used.

The power supply module is used for the supply and replenishment of the power supply of the whole system. In this embodiment, the power supply module may be composed of a lithium battery charging chip, a voltage regulating chip for each part, and a power distribution network, etc.

A mobile phone includes mobile phone application software and a man-machine interface controlled by back-end cloud communication, a mobile network and a mobile network base station, etc. The mobile phone is mainly used to authenticate the random password information of the biometric wireless key and the random password information downloaded from the cloud.

The cloud, including the cloud server and cloud program, is used for storing and exchanging all information of the biometric wireless key.

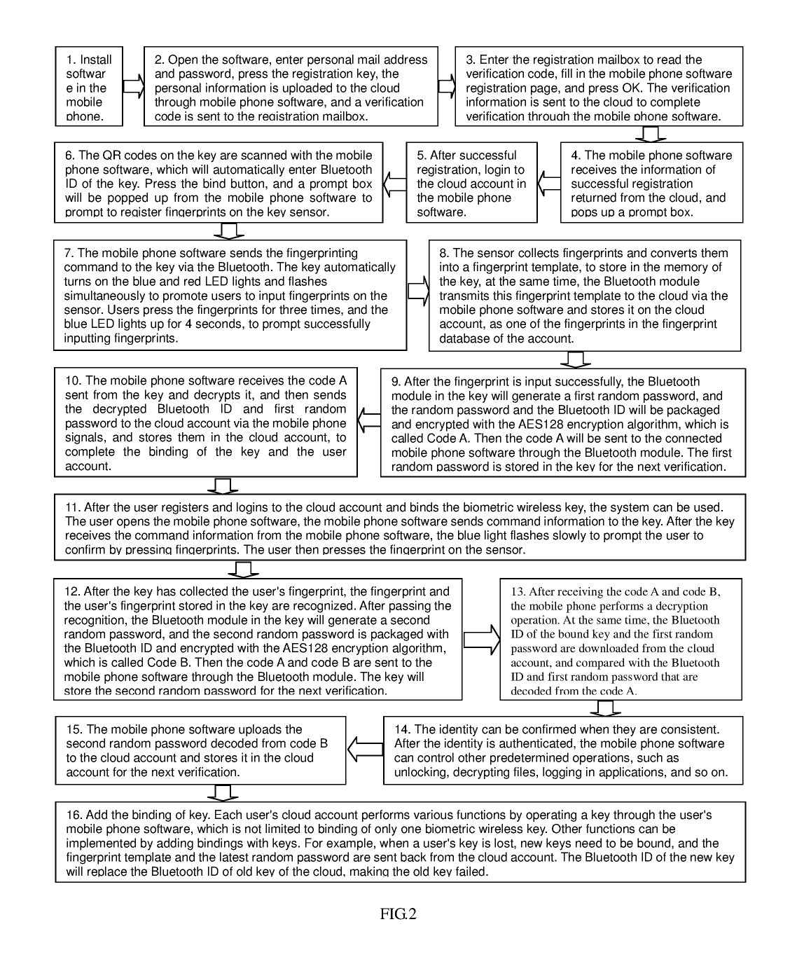

Before authenticating, it is necessary to register the cloud account, connect the cloud account to the mobile phone, and bind the cloud account to the biometric wireless key, and then enter the authentication stage. The whole process is shown in FIG. 2.

Cloud account registration: Users download and install software on their mobile phones, open the software to prompt users to register or login. After entering the personal email address and password and pressing OK, the mobile phone software uploads the registration information to the cloud via the mobile phone signals, and the cloud program sends an authentication request to enter personal mail, then users immediately enter the mailbox to read the verification code, fill in the mobile phone software registration page, and press OK. The verification code is uploaded to the cloud through the mobile phone software. The cloud program compares the verification code and determines the identity, to complete the cloud registration after passing, and then the information is returned to the mobile phone software. A pop-up prompt box prompts that users have successfully registered the cloud accounts.

It should be noted that the above-mentioned personal email address is applications in one embodiment. In other embodiments, all the information available for registering an account, such as a mobile phone number, a QQ number, etc., can satisfy the requirements of the present application.

Account login: Users login to the cloud account in the mobile phone software (mobile phone app), to achieve the connection between the mobile phone software and the cloud.

In a preferred embodiment, this login state will remain in memory unless the user actively logs out, or the mobile phone software is uninstalled and re-installed that will require re-login. Each personal cloud account allows only one mobile phone software to login at the same time, if a user logins again in another mobile phone, the mobile phone that logins previously will be forced to log out.

The biometric wireless key is bound to the cloud account and fingerprint information is transmitted to the cloud. Specifically, the QR code on the biometric wireless key can be scanned with the mobile phone software, which will automatically read Bluetooth ID (the unique identity code) of the biometric wireless key and establish a Bluetooth connection with the biometric wireless key. At this time, press the bind button on the mobile phone software page, and a prompt box will be popped up from the mobile phone software to prompt to register fingerprints on the fingerprint sensor.

The mobile phone software sends the fingerprinting command to the biometric wireless key via the Bluetooth signal. The biometric wireless key automatically turns on the blue and red LED lights and flashes simultaneously to promote users to input fingerprints on the sensor. Users press the fingerprints for three times, and the blue LED lights up for 4 seconds, to prompt successfully inputting fingerprints. The sensor collects fingerprints and converts them into a fingerprint template. The user's fingerprint template is stored in the memory within the biometric wireless key, at the same time, the Bluetooth module of the biometric wireless key transmits this fingerprint template to the cloud via the mobile phone software and stores it on the cloud account, as one of the fingerprint templates in the fingerprint database of the account.

After the fingerprint is input successfully, the Bluetooth module in the biometric wireless key will generate a first random password, and the random password and the Bluetooth ID will be packaged and encrypted with the AES128 encryption algorithm, which is called Code A. Then the code A will be sent to the connected mobile phone software through the Bluetooth module. The first random password is stored in the biometric wireless key for the next verification.

The mobile phone software receives the code A sent from the biometric wireless key, performs AES128 decryption of the code A, and sends the decrypted Bluetooth ID and first random password to the cloud account via the mobile phone signals, and stores them in the cloud account, to complete the binding of the biometric wireless key and the user account.

It should be noted that this random password uploaded to the cloud belongs to the user's account, not just the bound biometric wireless key itself because the user should use this random password when replacing the biometric wireless key. After the Bluetooth ID of the bound biometric wireless key and the random password generated for the first time are uploaded to the cloud and stored, the two important passwords will be deleted from the mobile phone software when the biometric wireless key is not used, which will not be stored in the mobile phone software. The mobile phone software may be uninstalled and reinstalled to lose data, or the user logins to the cloud account in another new mobile phone.

After the user registers and logins to the cloud account and binds the biometric wireless key, the system can be used. The user opens the mobile phone software, the mobile phone software sends command information to the biometric wireless key. After the biometric wireless key receives the command information from the mobile phone software, the blue light flashes slowly to prompt the user to confirm by pressing fingerprints. The user then presses the fingerprint on the sensor. After the biometric wireless key has collected the user's fingerprint, the fingerprint template is compared with the user's fingerprint template stored in the biometric wireless key. After passing the recognition, the Bluetooth module in the biometric wireless key will generate a second random password, and the second random password is packaged with the Bluetooth ID of the biometric wireless key and encrypted with the AES128 encryption algorithm, which is called Code B. Then the previous code A and this code B are sent to the mobile phone software through the Bluetooth module. The biometric wireless key will store the second random password for the next verification.

After receiving the code A and code B, the mobile phone performs a decryption operation. At the same time, the Bluetooth ID of the bound biometric wireless key and the first random password are downloaded from the cloud account, and compared with the Bluetooth ID and first random password that are decoded from the code A. The identity can be confirmed when they are consistent. After the identity is authenticated, the mobile phone software can control other predetermined operations, such as unlocking, decrypting files, logging in applications, and so on. Finally, the mobile phone software uploads the second random password decoded from code B to the cloud account and stores it in the cloud account for the next verification.

In addition, the present invention needs to add the binding of biometric wireless key. Each user's cloud account performs various functions by operating a biometric wireless key through the user's mobile phone software, which is not limited to binding of only one biometric wireless key. Other functions can be implemented by adding bindings with biometric wireless keys. For example, when a user's biometric wireless key is lost, the new biometric wireless key needs to be bound, and the fingerprint template and the latest random password are sent back from the cloud account. The Bluetooth ID of the new biometric wireless key will replace the Bluetooth ID of old biometric wireless key of the cloud, making the old biometric wireless key failed.

It should be noted that, the mobile phone obtains the first encrypted data corresponding to the random password from the biometric wireless key when the previous verification succeeds for each time of verification in the present invention, and performs comparative verification with the previous random data stored in the cloud. However, the mobile phone does not necessarily obtain the second encrypted data corresponding to the random password generated when this verification succeeds from the biometric wireless key simultaneously for each time of verification. The random password required for the next verification can be generated at any time before the new verification request occurs, as long as the random password has been transmitted to the cloud. Specifically, the generation and transmission time can be freely set or other conditions can be set to stimulate. Of course, since the time for the next verification request is unpredictable, it is preferred to complete the generation, transmission, and storage of the random password required for the next verification for each time of verification. It can be expected that, if the time interval for two authentication requests is mandatory, then the generation, transmission and storage of random password for the next time can be set.

In the present invention, the transmitted random password will be deleted from the mobile phone within a certain period of time, since the mobile phone is less prone to loss within a short period of time. At this time, if a next verification request is issued, the mobile phone can directly perform verification without acquiring data from the cloud, to save the time.

To sum up, the present invention provides a wireless network-based biometric authentication system, comprising a biometric authentication device, a mobile device, and a cloud device;

Wherein the biometric authentication device is configured to authenticate the biometric input by the user and send first encrypted data to the mobile device via Bluetooth communication when the authentication succeeds; the first encrypted data are obtained by encrypting a first random password and an identity code of the biometric authentication device; and the first random password is generated when the previous authentication of the biometric authentication device succeeds;

The mobile device is configured to decrypt the first encrypted data to obtain a first random password and an identity authentication identification code, and download first random information and identity information of the biometric authentication device from the cloud device; first random information and identity information are transmitted to the cloud device from the mobile device;

The mobile device is further configured to pass the verification when the first random password corresponds to the first random information and the identity code corresponds to the identity information.

In preferred embodiments, the random password for the next verification is generated and transmitted simultaneously, that is, the biometric authentication device is further configured to send second encrypted data to the mobile device via Bluetooth communication when the authentication succeeds, and the second encrypted data are obtained by encrypting a second random password and an identity code; the second random password is generated when the biometric authentication device succeeds in this authentication;

The mobile device is further configured to decrypt the second encrypted data to obtain a second random code and an identity authentication identification code, and transmit the second random information corresponding to the second random password and the identity information corresponding to the identity authentication identification code to the cloud device.

When there is a new binding request, the cloud device is also configured to send biometric information to a new biometric authentication device through a mobile device and store the identity code of the new biometric authentication device. The biometric authentication device and cloud device store biometric information, which corresponds to the identity information.

The present invention provides a wireless network-based mobile device, comprising a communication unit, a decryption unit and a verification unit;

the communication unit is used to used to receive first encrypted data sent by the biometric authentication device and first random information and identity information of the biometric authentication device sent by the cloud device; the first random information and identity information are transmitted to the cloud device by the transmission unit; the first encrypted data are sent via Bluetooth communication when the biometric authentication device successfully authenticates biometrics input by users; the first encrypted data are obtained by encrypting the first random password and the identity code of the biometric authentication device by the biometric authentication device; the first random password is generated when the biometric authentication device succeeds in the previous authentication;

the decryption is used to decrypt the first encrypted data to obtain a first random password and an identity authentication identification code;

the verification unit is used to pass the verification when the first random password corresponds to the first random information and the identity code corresponds to the identity information.

the communication unit is further used to receive second encrypted data transmitted via Bluetooth communication when the biometric authentication device succeeds in authentication, and the second encrypted data are obtained by encrypting the second random password and the identity code; the second random password is generated when the biometric authentication device succeeds in this authentication;

the decryption unit is further used to decrypt the second encrypted data to obtain a second random password and an identity authentication identification code;

the communication unit is further used to transmit the second random information corresponding to the second random password and the identity information corresponding to the identity authentication identification code to the cloud device.

The communication unit is further used to receive the biometric information sent by the cloud device and send it to a new biometric authentication device, and send the identity information corresponding to the identity code of the new biometric authentication device to a new biometric device, the biometric information is sent by the cloud device when receiving a request of replacing or adding a new biometric authentication device;

The biometric information corresponds to identity information.

Based on the foregoing system and mobile device, the present invention further discloses a wireless network-based biometric authentication method applied in the foregoing system, comprising:

a biometric authentication device authenticates the biometrics input by a user and sends first encrypted data to a mobile device via Bluetooth communication when the authentication succeeds; the first encrypted data are obtained by encrypting the first random password and the identification code of the biometric authentication device; the first random password is generated when the biometric authentication device succeeds in the previous authentication;

a mobile device decrypts the first encrypted data to obtain the first random password and the identity authentication identification code, and downloads the first random information and the identity information of the biometric authentication device from the cloud device; the first random information and the identity information are transmitted to the cloud device by the mobile device;

The mobile device is used to pass the verification when the first random password corresponds to the first random information and the identity code corresponds to the identity information.

Preferably, a biometric authentication device sends second encrypted data to the mobile device via Bluetooth communication when the authentication succeeds, and the second encrypted data are obtained by encrypting the second random password and the identity code; the second random password is generated when the biometric authentication device succeeds in this authentication;

A mobile device decrypts the second encrypted data to obtain a second random password and an identity authentication identification code and transmits the second random information corresponding to the second random password and the identity information corresponding to the identity authentication identification code to the cloud device.

Preferably, the biometric authentication device and the cloud device store biometric information, and the biometric information corresponds to the identity information;

The cloud device sends the biometric information to a new biometric authentication device via the mobile device and stores the identity code of the new biometric authentication device when receiving a request of replacing or adding a new biometric authentication device.

The present invention is described by embodiments but it does not constitute limitations to the invention. Other changes or modifications made with reference to the description and embodiments disclosed herein, which are easily envisaged by those skilled in the art shall fall within the scope defined by the appended claims in the present invention.

1. A wireless network-based biometric authentication system, comprising a biometric authentication device, a mobile device, and a cloud device;
Wherein the biometric authentication device is configured to authenticate the biometric input by the user and send first encrypted data to the mobile device via Bluetooth communication when the authentication succeeds; the first encrypted data are obtained by encrypting a first random password and an identity code of the biometric authentication device; and the first random password is generated when the previous authentication of the biometric authentication device succeeds;
The mobile device is configured to decrypt the first encrypted data to obtain a first random password and an identity authentication identification code, and download first random information and identity information of the biometric authentication device from the cloud device; first random information and identity information are transmitted to the cloud device from the mobile device;
The mobile device is further configured to pass the verification when the first random password corresponds to the first random information and the identity code corresponds to the identity information.

2. The wireless network-based biometric authentication system according to claim 1, wherein the biometric authentication device is further configured to send second encrypted data to the mobile device via Bluetooth communication when the authentication succeeds, and the second encrypted data are obtained by encrypting a second random password and an identity code; the second random password is generated when the biometric authentication device succeeds in this authentication;
The mobile device is further configured to decrypt the second encrypted data to obtain a second random code and an identity authentication identification code, and transmit the second random information corresponding to the second random password and the identity information corresponding to the identity authentication identification code to the cloud device.

3. The wireless network-based biometric authentication system according to claim 2, wherein the biometric authentication device and the cloud device store biometric information, and the biometric information corresponds to the identity information;
The cloud device is further configured to send the biometric information to a new biometric authentication device via the mobile device and store the identity code of the new biometric authentication device when receiving a request of replacing or adding a new biometric authentication device.

4. The wireless network-based biometric authentication system according to claim 2, wherein the biometric authentication device is obtained through an AES128 encryption algorithm.

5. A wireless network-based mobile device, comprising a communication unit, a decryption unit and a verification unit;
the communication unit is used to used to receive first encrypted data sent by the biometric authentication device and first random information and identity information of the biometric authentication device sent by the cloud device; the first random information and identity information are transmitted to the cloud device by the transmission unit; the first encrypted data are sent via Bluetooth communication when the biometric authentication device successfully authenticates biometrics input by users; the first encrypted data are obtained by encrypting the first random password and the identity code of the biometric authentication device by the biometric authentication device; the first random password is generated when the biometric authentication device succeeds in the previous authentication;
the decryption is used to decrypt the first encrypted data to obtain a first random password and an identity authentication identification code;
the verification unit is used to pass the verification when the first random password corresponds to the first random information and the identity code corresponds to the identity information.

6. The wireless network-based mobile device according to claim 5, wherein the communication unit is further used to receive second encrypted data transmitted via Bluetooth communication when the biometric authentication device succeeds in authentication, and the second encrypted data are obtained by encrypting the second random password and the identity code; the second random password is generated when the biometric authentication device succeeds in this authentication;
the decryption unit is further used to decrypt the second encrypted data to obtain a second random password and an identity authentication identification code;
the communication unit is further used to transmit the second random information corresponding to the second random password and the identity information corresponding to the identity authentication identification code to the cloud device.

7. The wireless network-based mobile device according to claim 6, wherein the communication unit is further used to receive the biometric information sent by the cloud device and send it to a new biometric authentication device, and send the identity information corresponding to the identity code of the new biometric authentication device to a new biometric device, the biometric information is sent by the cloud device when receiving a request of replacing or adding a new biometric authentication device;
The biometric information corresponds to identity information.

8. A wireless network-based biometric authentication method applied in the system of any one of claims 1 to 4, comprising:
a biometric authentication device authenticates the biometrics input by a user and sends first encrypted data to a mobile device via Bluetooth communication when the authentication succeeds; the first encrypted data are obtained by encrypting the first random password and the identification code of the biometric authentication device; the first random password is generated when the biometric authentication device succeeds in the previous authentication;
a mobile device decrypts the first encrypted data to obtain the first random password and the identity authentication identification code, and downloads the first random information and the identity information of the biometric authentication device from the cloud device; the first random information and the identity information are transmitted to the cloud device by the mobile device;
The mobile device is used to pass the verification when the first random password corresponds to the first random information and the identity code corresponds to the identity information.

9. The wireless network-based biometric authentication method according to claim 8, wherein a biometric authentication device sends second encrypted data to the mobile device via Bluetooth communication when the authentication succeeds, and the second encrypted data are obtained by encrypting the second random password and the identity code; the second random password is generated when the biometric authentication device succeeds in this authentication;
a mobile device decrypts the second encrypted data to obtain a second random password and an identity authentication identification code and transmits the second random information corresponding to the second random password and the identity information corresponding to the identity authentication identification code to the cloud device.

10. The wireless network-based biometric authentication method according to claim 9, wherein the biometric authentication device and the cloud device store biometric information, and the biometric information corresponds to the identity information;
The cloud device sends the biometric information to a new biometric authentication device via the mobile device and stores the identity code of the new biometric authentication device when receiving a request of replacing or adding a new biometric authentication device.
